(19) United States
(12) Patent Application Publication
(10) Pub. No.: US 2026/0162151 A1
(43) Pub. Date: Jun. 11, 2026

(54) METHOD AND COMPUTER DEVICE TO EXAMINE ADVERTISING MATERIALS BASED ON SIMILARITY

(71) Applicant: NAVER CORPORATION, Seongnam-si (KR)

(72) Inventor: Yohan BAE, Seongnam-si (KR)

(21) Appl. No.: 19/378,709

(22) Filed: Nov. 4, 2025

(30) Foreign Application Priority Data
Dec. 6, 2024 (KR) 10 2024 0180878

(51) Int. Cl. G06Q 30/0241

(52) U.S. Cl. CPC G06Q 30/0277

(57) ABSTRACT

An advertising material review method may include registering a material input from an advertiser as a material to be reviewed; recommending a material similar to the material to be reviewed based on similarity between materials; and batch-approving at least one material among the similar materials with the material to be reviewed.

This U.S. non-provisional application claims the benefit of priority under 35 U.S.C. § 119 to Korean Patent Application No. 10-2024-0180878 filed on December 06, 2024, in the Korean Intellectual Property Office (KIPO), the entire contents of which are incorporated herein by reference.

### BACKGROUND OF THE INVENTION

### Field of Invention

One or more example embodiments of the following description of the present invention relate to technology for reviewing an advertising material registered by an advertiser.

### Description of Related Art

Currently, with the development of communication technology, such as the Internet, Internet users spend a lot of time and visiting many sites through connection to the Internet. Therefore, many advertisers show greater interest in online advertising to promote their products or services. Most advertisers request advertising from advertising agencies or Internet site operators that include portal sites.

There may be various methods to initiate online advertising. Most advertising methods may target and display corresponding advertisements to users who are expected to have high interest using advertising images and phrases.

Upon requests from advertisers to launch advertisements, advertising agencies need to conduct a review procedure for the requested advertisements. If the advertising agencies immediately launch the advertisements requested by the advertisers without going through any review process, the advertisements may be ineffective. In addition, an advertisement that users truly desire may not be provided. Also, harmful and illegal advertisements may be indiscriminately provided.

Conventionally, the advertising agencies review corresponding advertising materials for all advertisements. Therefore, the advertising agencies spend a lot of time and money on an advertising review process. Also, there is inefficiency in that a relatively unimportant advertisement needs to go through the same review procedure as other important advertisements.

As an example of advertising material review technology, Korean Patent Laid-Open Publication No. 10-2009-0124640 (published on December 3, 2009) describes technology for setting an advertising guide corresponding to an advertising material and reviewing whether an advertising material input as a subject to review matches settings of the advertising guide.

### BRIEF SUMMARY OF THE INVENTION

One or more example embodiments of the present invention may provide a function of batch-reviewing materials similar to a material to be reviewed in an advertising review process.

One or more example embodiments may recommend materials similar to a material to be reviewed through a similarity-based recommendation logic that applies various options.

One or more example embodiments may select at least some materials from among recommended materials, and may approve and process the selected materials with a material to be reviewed.

According to at least one example embodiment, there is provided an advertising material review method of a computer device including at least one processor, the method including registering, by the at least one processor, a material input from an advertiser as a material to be reviewed; recommending, by the at least one processor, a material similar to the material to be reviewed based on similarity between materials; and batch-approving, by the at least one processor, at least one material among the similar materials with the material to be reviewed.

According to an aspect of the present invention, the registering may include managing the material registered by the advertiser through a material database (DB) by listing the material as the material to be reviewed.

According to another aspect, the recommending may include recommending a material of an image similar to an image of the material to be reviewed using similarity between images with respect to images registered as advertising materials.

According to still another aspect, the recommending may include calculating similarity between features extracted from the respective images with respect to images registered as advertising materials, and selecting an image having similarity greater than or equal to a threshold with an image of the material to be reviewed as a recommended material.

According to still another aspect, the batch-approving may include approving at least one material selected by a reviewer from among the similar materials and the material to be reviewed.

According to still another aspect, the recommending may include performing image tuning on an image registered as an advertising material according to an option requested by a reviewer; and selecting an image similar to an image of the material to be reviewed as a recommended material based on similarity between tuned images.

According to still another aspect, the image tuning may include at least one of background removal, color removal, edge detection, and character removal.

According to still another aspect, the recommending may include calculating image similarity by comparing an additional factor between advertising materials according to an option requested by a reviewer when calculating similarity between images with respect to images registered as advertising materials.

According to still another aspect, the additional factor may include at least one of a campaign objective, a creative template, a placement location, an advertising phrase, a landing uniform resource locator (URL), and a representative image color.

According to still another aspect, the additional factor may include an image caption that is generated through a large language model (LLM) with respect to the images registered as the advertising materials.

According to still another aspect, the advertising material review method may further include training, by the at least one processor, a recommendation model for the similar material using a material approved with the material to be reviewed.

According to at least one example embodiment, there is provided a non-transitory computer-readable recording medium storing instructions that, when executed by a processor, cause the processor to execute the advertising material review method on the computer device.

According to at least one example embodiment, there is provided a computer device including at least one processor configured to execute computer-readable instructions, wherein the at least one processor is configured to register a material input from an advertiser as a material to be reviewed; recommend a material similar to the material to be reviewed based on similarity between materials; and batch-approve at least one material among the similar materials with the material to be reviewed.

According to some example embodiments, it is possible to more quickly and efficiently perform a review procedure by providing a function of batch-reviewing materials similar to a material to be reviewed in an advertising review process.

According to some example embodiments, it is possible to provide an optimized review environment by selectively applying at least one option among various options to a similarity-based recommendation logic and by recommending materials similar to a material to be reviewed.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an example of a network environment according to one example embodiment;

FIG. 2 is a block diagram illustrating an example of a computer device according to one example embodiment;

FIG. 3 is a flowchart illustrating an example of a method performed by a computer device according to one example embodiment;

FIG. 4 illustrates an example of an advertising structure registered on an advertising platform according to one example embodiment;

FIG. 5 illustrates an example of a similar material recommendation process according to one example embodiment;

FIGS. 6 to 8 illustrate examples of an advertising review service screen according to at least one example embodiment; and

FIG. 9 illustrates an example of training a material recommendation model according to one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by the example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms "first," "second," "third," etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as "beneath," "below," "lower," "under," "above," "upper," and the like, may be used herein for ease of description to describe one element or feature's relationship to another element(s) or feature (s) as illustrated in the figures. It will be understood that the spatially relative terms are intended to encompass different orientations of the device in use or operation in addition to the orientation depicted in the figures. For example, if the device in the figures is turned over, elements described as "below," "beneath," or "under," other elements or features would then be oriented "above" the other elements or features. Thus, the example terms "below" and "under" may encompass both an orientation of above and below. The device may be otherwise oriented (rotated 90 degrees or at other orientations) and the spatially relative descriptors used herein interpreted accordingly. In addition, when an element is referred to as being "between" two elements, the element may be the only element between the two elements, or one or more other intervening elements may be present.

As used herein, the singular forms "a," "an," and "the," are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups, thereof. As used herein, the term "and/or" includes any and all combinations of one or more of the associated listed products. Expressions such as "at least one of," when preceding a list of elements, modify the entire list of elements and do not modify the individual elements of the list. Also, the term "exemplary" is intended to refer to an example or illustration.

When an element is referred to as being "on," "connected to," "coupled to," or "adjacent to," another element, the element may be directly on, connected to, coupled to, or adjacent to, the other element, or one or more other intervening elements may be present. In contrast, when an element is referred to as being "directly on," "directly connected to," "directly coupled to," or "immediately adjacent to," another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments of the present invention will be described with reference to the accompanying drawings.

The example embodiments relate to technology for reviewing an advertising material registered by an advertiser.

The example embodiments including disclosures herein may provide a rapid and efficient review environment by providing a function of batch-reviewing materials similar to a material to be reviewed in an advertising review process.

An advertising material review apparatus according to the example embodiments may be implemented by at least one computer device, and an advertising material review method according to the example embodiments may be performed through at least one computer device included in the advertising material review apparatus according to the example embodiments. Here, a computer program according to an example embodiment may be installed and executed on the computer device, and the computer device may perform the advertising material review method according to the example embodiments under the control of the executed computer program. The aforementioned computer program may be stored in a computer-readable recording medium to computer-implement the advertising material review method in conjunction with the computer device.

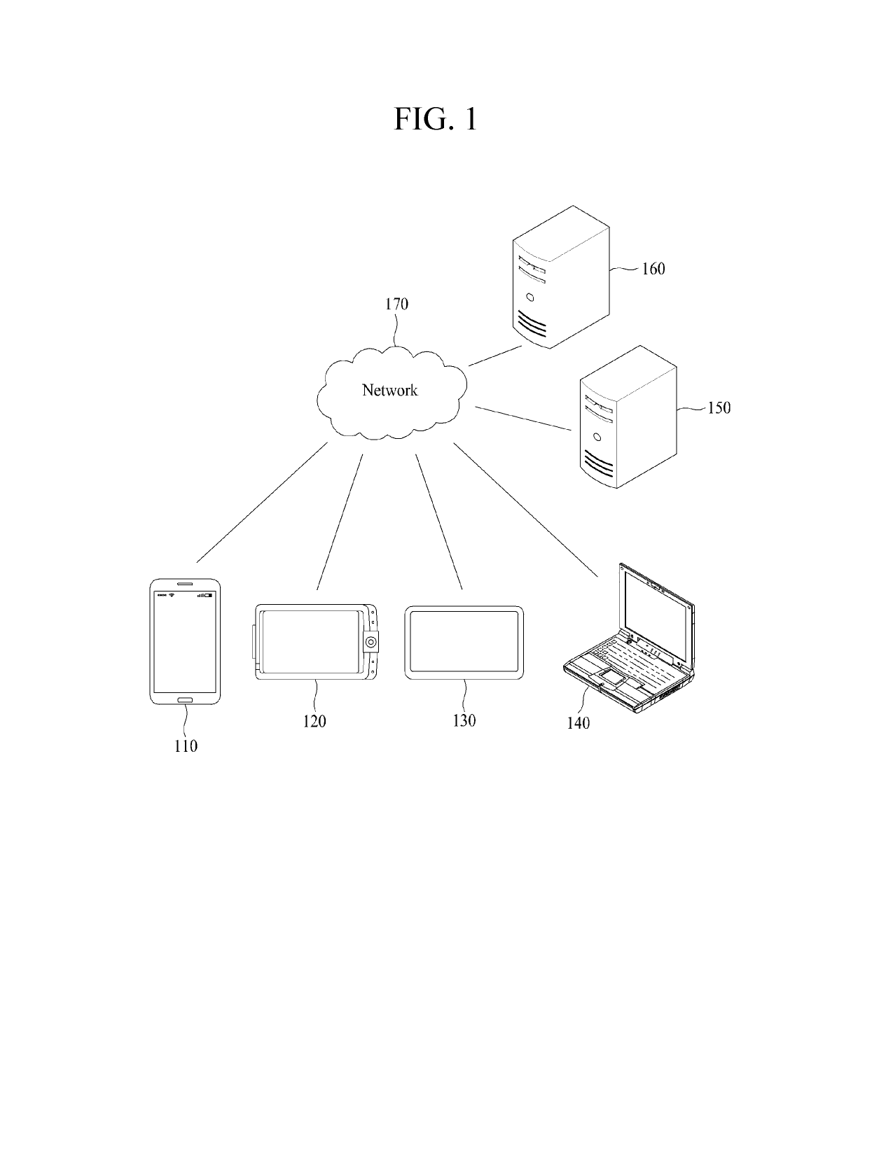

FIG. 1 illustrates an example of a network environment according to at least one example embodiment. Referring to FIG. 1, the network environment may include a plurality of electronic devices 110, 120, 130, 140, a plurality of servers 150, 160, and a network 170. FIG. 1 is provided as an example only. The number of electronic devices or the number of servers is not limited thereto. Also, the network environment of FIG. 1 describes one example among environments applicable to the example embodiments and an environment applicable to the example embodiments is not limited to the network environment of FIG. 1.

Each of the plurality of electronic devices 110, 120, 130, 140 may be a fixed terminal or a mobile terminal that is configured as a computer device. For example, the plurality of electronic devices 110, 120, 130, 140 may be a smartphone, a mobile phone, a navigation device, a computer, a laptop computer, a digital broadcasting terminal, a personal digital assistant (PDA), a portable multimedia player (PMP), a tablet personal computer (PC), and the like. For example, although FIG. 1 illustrates a shape of a smartphone as an example of the electronic device 110, the electronic device 110 used herein may refer to one of various types of physical computer devices capable of communicating with other electronic devices 120, 130, 140, and/or the servers 150, 160 over the network 170 in a wireless or wired communication manner.

The communication scheme is not limited and may include a near field wireless communication scheme between devices as well as a communication scheme using a communication network (e.g., mobile communication network, wired Internet, wireless Internet, broadcasting network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150, 160 may be configured as a computer device or a plurality of computer devices that provides an instruction, a code, a file, content, a service, etc., through communication with the plurality of electronic devices 110, 120, 130, 140 over the network 170. For example, the server 150 may be a system that provides a service (e.g., advertising review service) to the plurality of electronic devices 110, 120, 130, 140 connected over the network 170.

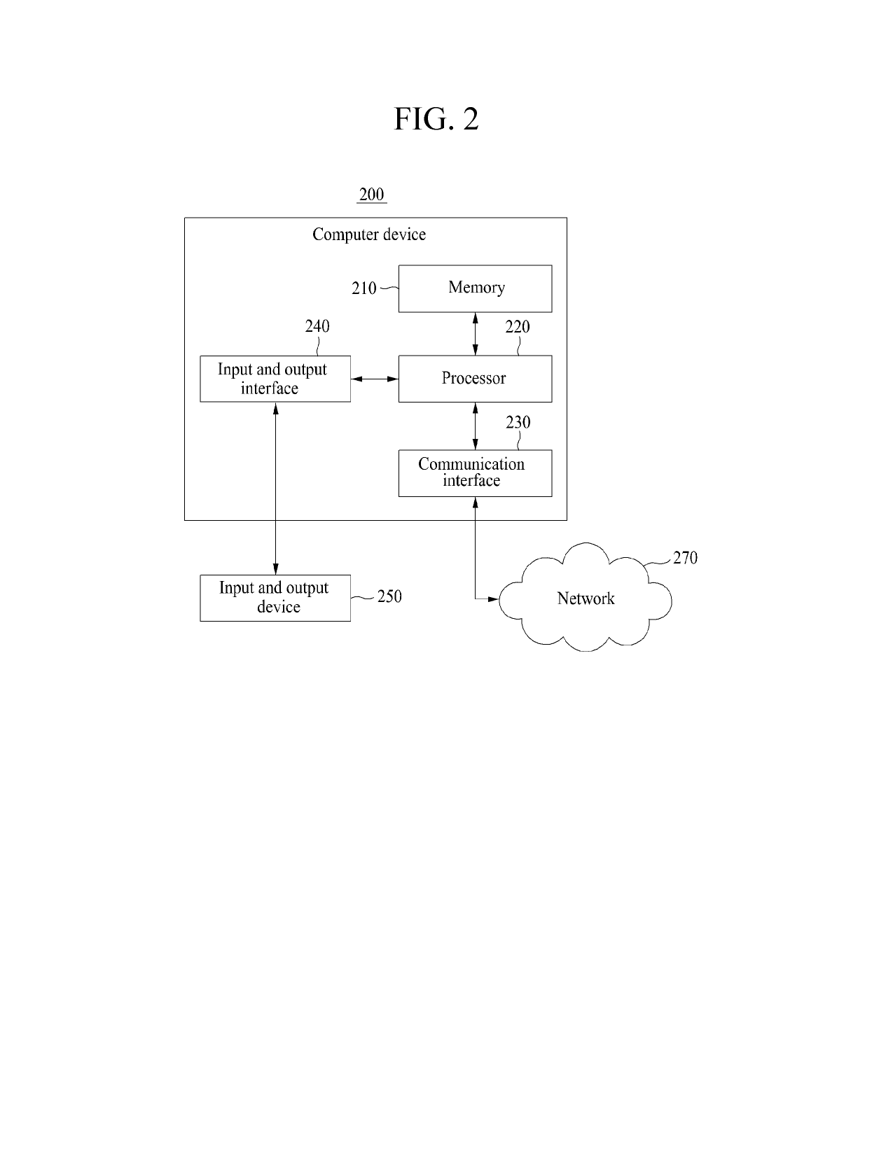

FIG. 2 is a block diagram illustrating an example of a computer device according to at least one example embodiment. Each of the plurality of electronic devices 110, 120, 130, 140 of FIG. 1 or each of the servers 150, 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable recording medium. The permanent mass storage device, such as a ROM and a disk drive, may be included in the computer device 200 as a permanent storage device separate from the memory 210. Also, an OS and at least one program code may be stored in the memory 210. Such software components may be loaded to the memory 210 from another non-transitory computer-readable recording medium separate from the memory 210. Other non-transitory computer-readable recording media may include a non-transitory computer-readable recording medium, for example, a floppy drive, a disk, a tape, a DVD/CD-ROM drive, a memory card, etc. According to other example embodiments, software components may be loaded to the memory 210 through the communication interface 230, instead of the non-transitory computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the communication apparatus 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under the control of the communication interface 230. Inversely, a signal, an instruction, data, a file, etc., from another apparatus may be received at the computer device 200 through the communication interface 230 of the computer device 200 over the network 170. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device of the I/O device 250 may include a device, such as a microphone, a keyboard, a mouse, etc., and an output device of the I/O device 250 may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to other example embodiments, the computer device 200 may include greater or less number of components than those shown in FIG. 2. For example, the computer device 200 may include at least a portion of the I/O device 250, or may further include other components, for example, a transceiver, a database, etc.

Hereinafter, detailed example embodiments of the present invention for reviewing advertising materials based on similarity are described.

A review process is required prior to advertising display for an advertisement registered by an advertiser to be actually displayed (executed) for users, i.e. targeted audience or consumers.

The purpose of advertising review is to manage the relevance or harmfulness of an advertising material, and to manage the advertising quality to ensure legal compliance of an advertising platform and management of media reputation risk as a platform operator.

An advertising review process may provide guidance on advertising display that the advertiser needs to comply with, such as reporting mail-order business and medical institution openings, and may reject materials that may raise concerns about third-party right, such as business with restricted online sales or counterfeit, and trademark infringement. Also, harmful advertisements may be filtered out for the purpose of protecting minors, and the minimum advertising quality may be ensured by verifying site connection or material resolution.

Currently, advertising review is conducted by entrusting an advertisement registered by an advertiser to a subsidiary of an advertising platform and by checking, by a person, materials one by one, which inevitably requires enormous cost and amount of time.

Therefore, the present invention may provide a review function using material similarity to reduce cost and an amount of time used for advertising review and to improve the efficiency of the review process.

The processor 220 of the computer device 200 may be implemented as a component for performing the following advertising material review method. Depending on example embodiments, the components of the processor 220 may be optionally included in or excluded from the processor 220. Also, depending on example embodiments, the components of the processor 220 may be separated or merged for functional representations of the processor 220.

The processor 220 and the components of the processor 220 may control the computer device 200 to perform operations included in the following advertising material review method. For example, the processor 220 and the components of the processor 220 may be implemented to execute an instruction according to a code of at least one program and a code of an operating system (OS) included in the memory 210.

Here, the components of the processor 220 may be representations of different functions performed by the processor 220 according to an instruction provided from a program code stored in the computer device 200.

The processor 220 may read a necessary instruction from the memory 210 to which instructions related to control of the computer device 200 are loaded. In this case, the read instruction may include an instruction for controlling the processor 220 to execute operations described below.

The operations included in the advertising material review method described below may be performed in order different from the illustrated order, and some of the operations may be omitted or an additional process may be further included.

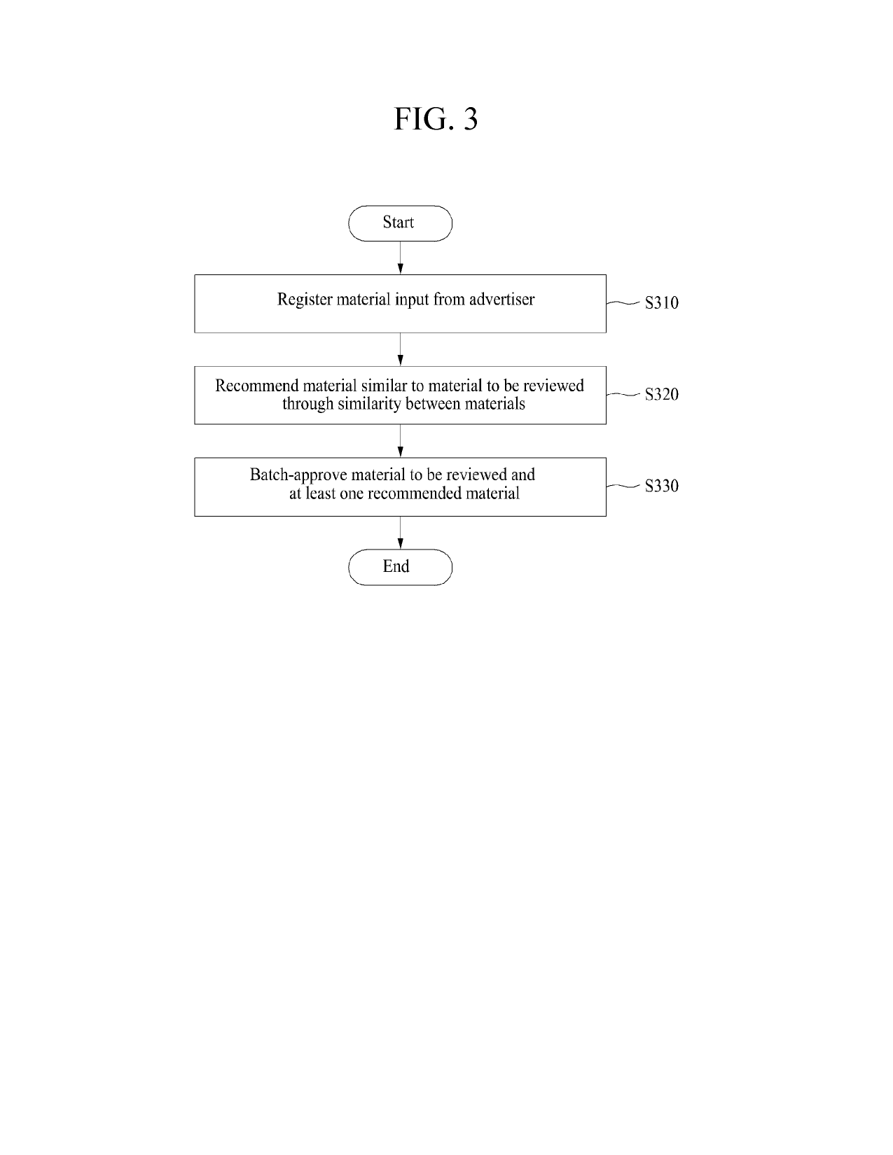

FIG. 3 is a flowchart illustrating an example of a method performed by a computer device according to at least one example embodiment.

Referring to FIG. 3, in operation S310, the processor 220 may store, in a database (DB), and register a material input from an advertiser. The processor 220 may manage a material registered by an advertiser through a material DB by listing the material as a material to be reviewed before advertising execution through which an advertisement is displayed to users, i.e., target audience or consumers. Here, an advertising material used refers to content that is subject to review and may represent content that is directly exposed, that is, displayed to the users. Each advertising material may be configured in a different type according to the advertising type (e.g., search advertising, display advertising, etc.). Here, in the case of search advertising, a phrase basically forms the core of a material, and an image, a sub-link, a price link, and the like may be included as an extended material. Also, in the case of display advertising, an advertising material may be in the form of a single image, a slide, or a video. In the example embodiment, an image registered as an advertising material may be subject to review.

In operation S320, in response to a review request for the material registered by the advertiser, the processor 220 may recommend a material similar to the material to be reviewed through similarity between materials. The processor 220 may calculate the similarity between materials based on a list of materials stored in the material DB, and may select and recommend the material similar to the material to be reviewed based on the similarity between materials. Here, for advertising material review, the processor 220 may recommend materials of an image similar to a corresponding image with respect to images registered as advertising materials. Here, an image similarity algorithm may be used. The processor 220 may extract an image feature for each of images included in the list of materials within the material DB, may calculate similarity between image features (e.g., cosine similarity, Euclidean distance, etc.), and may recommend at least one image whose similarity is greater than or equal to a threshold with the image corresponding to the material to be reviewed, as a recommended material.

In operation S330, the processor 220 may batch-approve the material to be reviewed and at least one recommended material. The image corresponding to the material to be reviewed and the image having the similarity greater than or equal to the threshold may be provided as recommended materials. Here, at least one material may be selected from among the recommended materials. The processor 220 may batch-approve at least one material selected by a reviewer (i.e., a person) from among the recommended materials and the material to be reviewed.

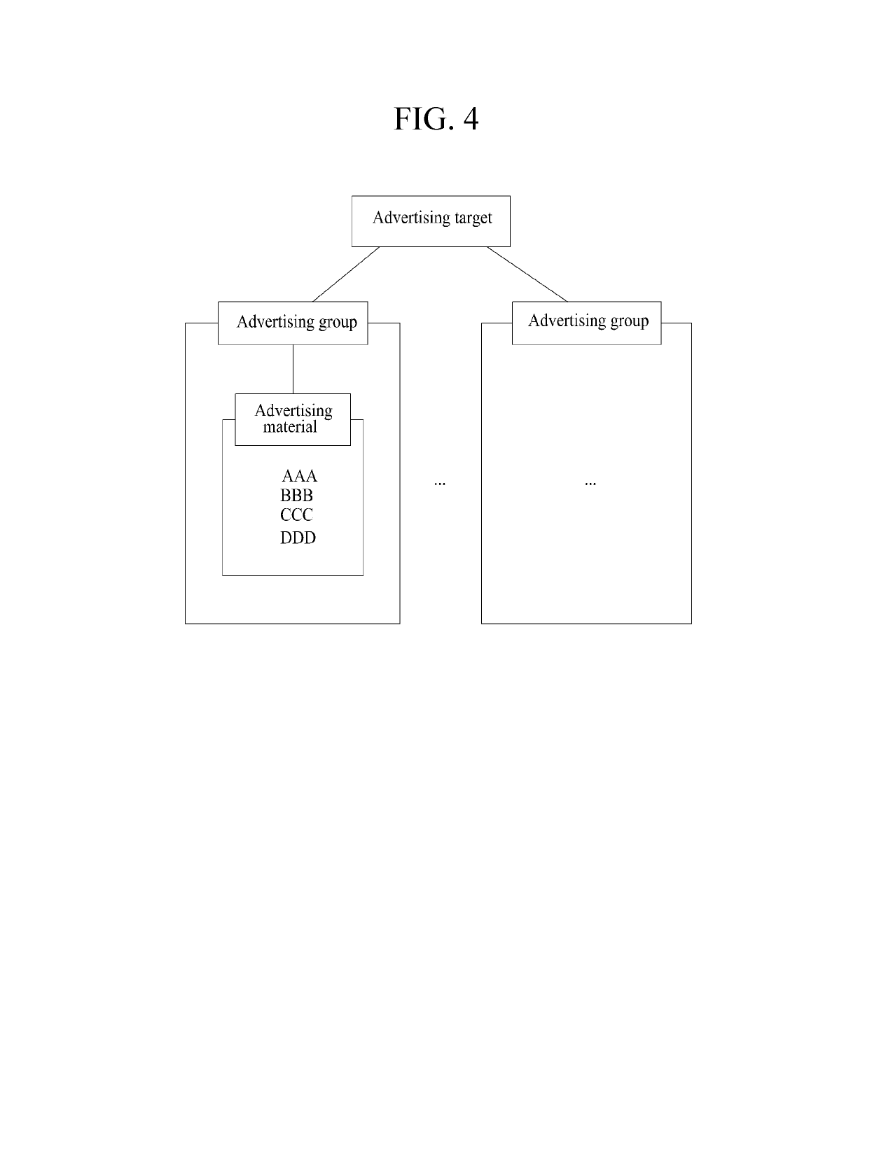

FIG. 4 illustrates an example of an advertising structure registered on an advertising platform according to one example embodiment.

The processor 220 may receive an advertising service application from an advertiser and may register an advertising material input from the advertiser to a material DB. An advertisement of the advertiser registered to the material DB may correspond to search advertising of a type shown in FIG. 4, for example.

For example, referring to FIG. 4, the advertiser may register a plurality of advertising groups for a single advertising target. A single advertising group includes a plurality of advertising materials, such as 'AAA', 'BBB', 'CCC' and 'DDD'.

The advertising material may include information on an advertisement as advertising content that is displayed for a user. For example, the advertising material may include title and description (T&D) that constitutes a text advertisement, an image, and a video.

One of the plurality of advertising materials (AAA, BBB, CCC, and DDD) registered by the advertiser to the advertising group may be selectively displayed.

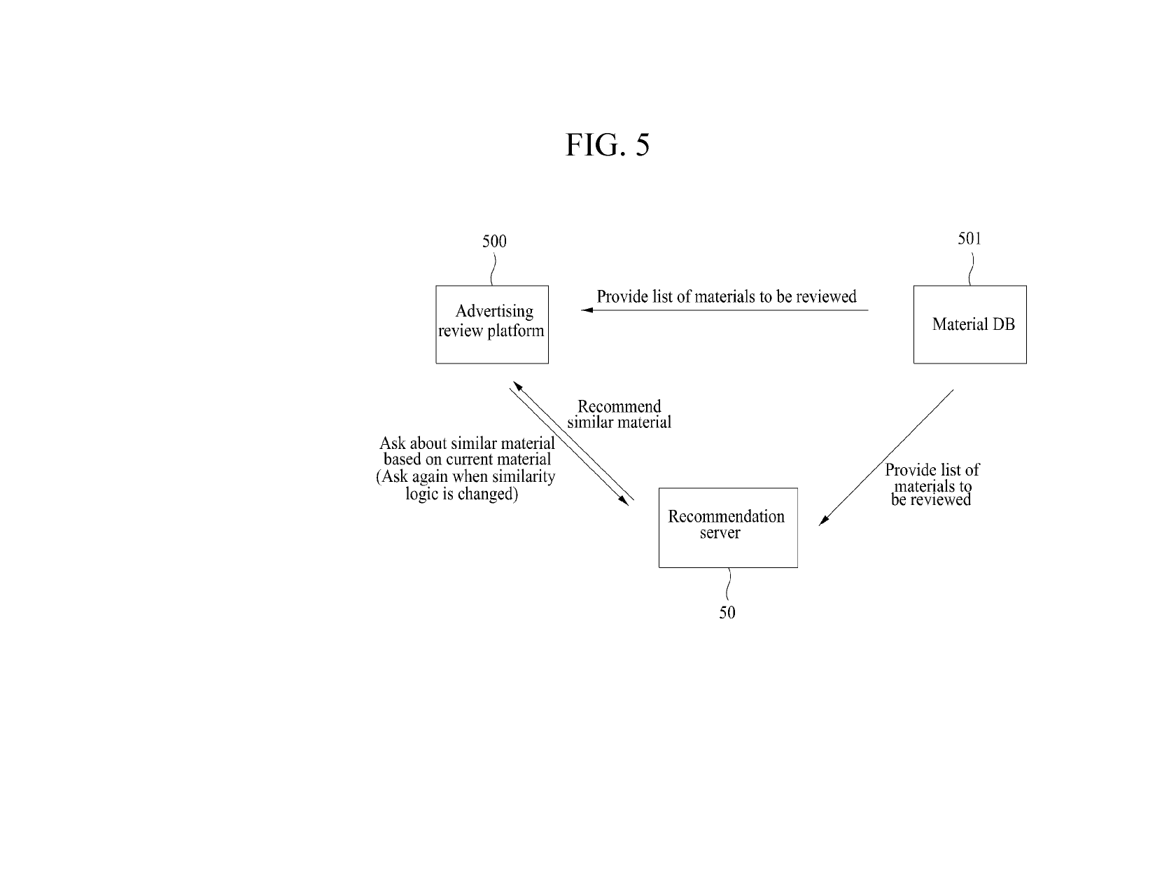

FIG. 5 illustrates an example of a similar material recommendation process according to at least one example embodiment.

Referring to FIG. 5, the processor 220 may provide an advertising review platform 500 for an advertising review service, and may recommend a similar material in conjunction with a recommendation server 50. The recommendation server 50 may be the same as the server providing the advertising review service, or it may refer to a core functional module within that server. The server providing the advertising review service may correspond to one of the servers 150, 160 shown in FIG. 1.

The advertising review platform 500 and the recommendation server 50 may receive a list of materials registered to a material DB 501. The material DB 501 may be located within the server providing the advertising review service, or it may refer to a separate storage device capable of communicating with the server providing the advertising review service. In other words, the material DB 501 is connected to the advertising material management server 150, which is responsible for the registration and management of advertising materials. It could be the internal storage of the server 150, or centralized data storage accessible by both server 150 and server 160.

When a material to be reviewed is specified through the advertising review platform 500, the processor 220 may request (inquire) the recommendation server 50 to recommend a similar material based on the material to be reviewed.

The recommendation server 50 may calculate similarity between image features based on features extracted from the respective images included in the list of materials through a similarity-based recommendation logic, and may provide an image that is similar by a threshold or more to an image corresponding to the material to be reviewed as a recommended material.

When an option for the similarity-based recommendation logic is added or changed upon a request from a reviewer (i.e., a person), the processor 220 may re-request a similar material recommendation for the material to be reviewed. Therefore, the recommendation server 50 may reflect a recommendation logic to a reviewer request option and may re-select and provide a material similar to the material to be reviewed through the recommendation logic.

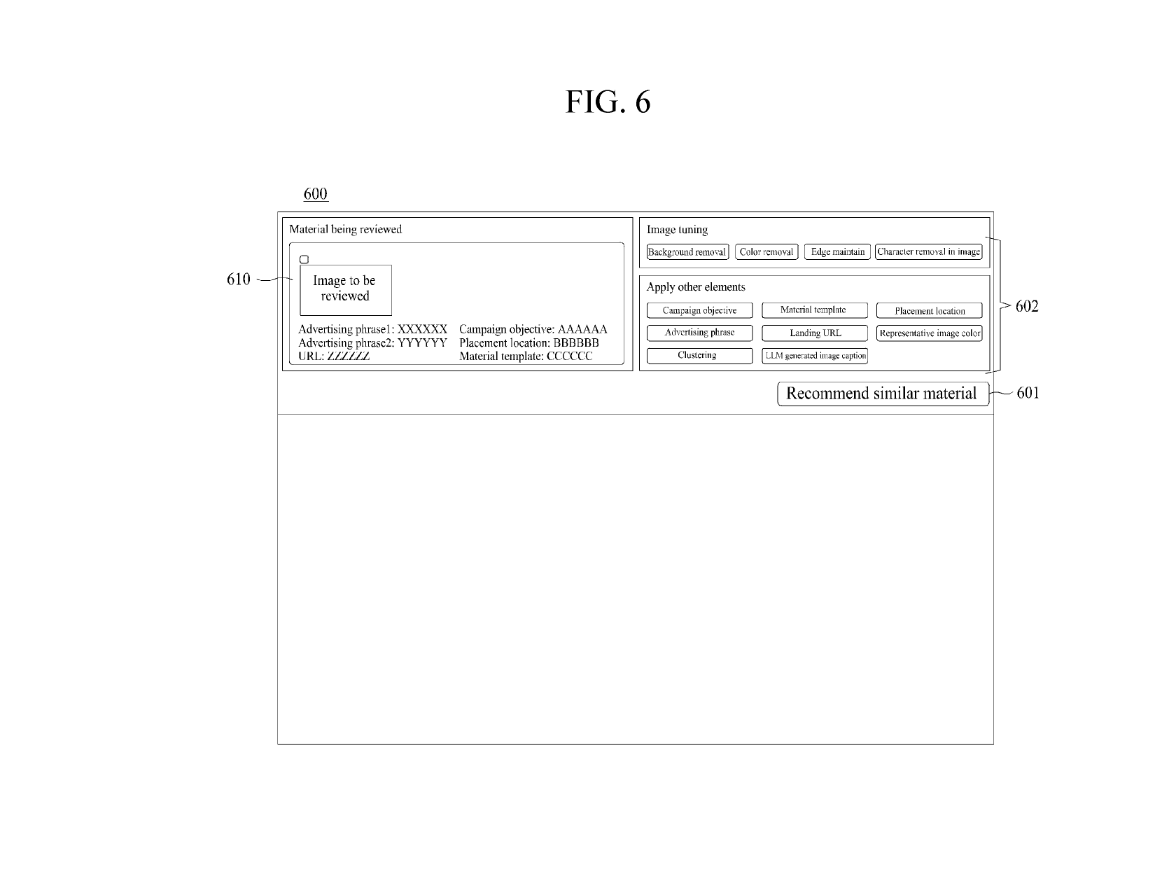

FIGS. 6 to 8 illustrate examples of an advertising review service screen according to at least one example embodiment.

Referring to FIG. 6, an advertising review service screen 600 may include a 'material to be reviewed' interface 610 for verifying a material to be reviewed and a 'recommend similar material' interface 601 for requesting recommendation of a material similar to the material to be reviewed.

A reviewer may verify an image or a phrase, a campaign, a placement location, a landing URL, and a material template of an advertising material to be reviewed through the 'material to be reviewed' interface 610.

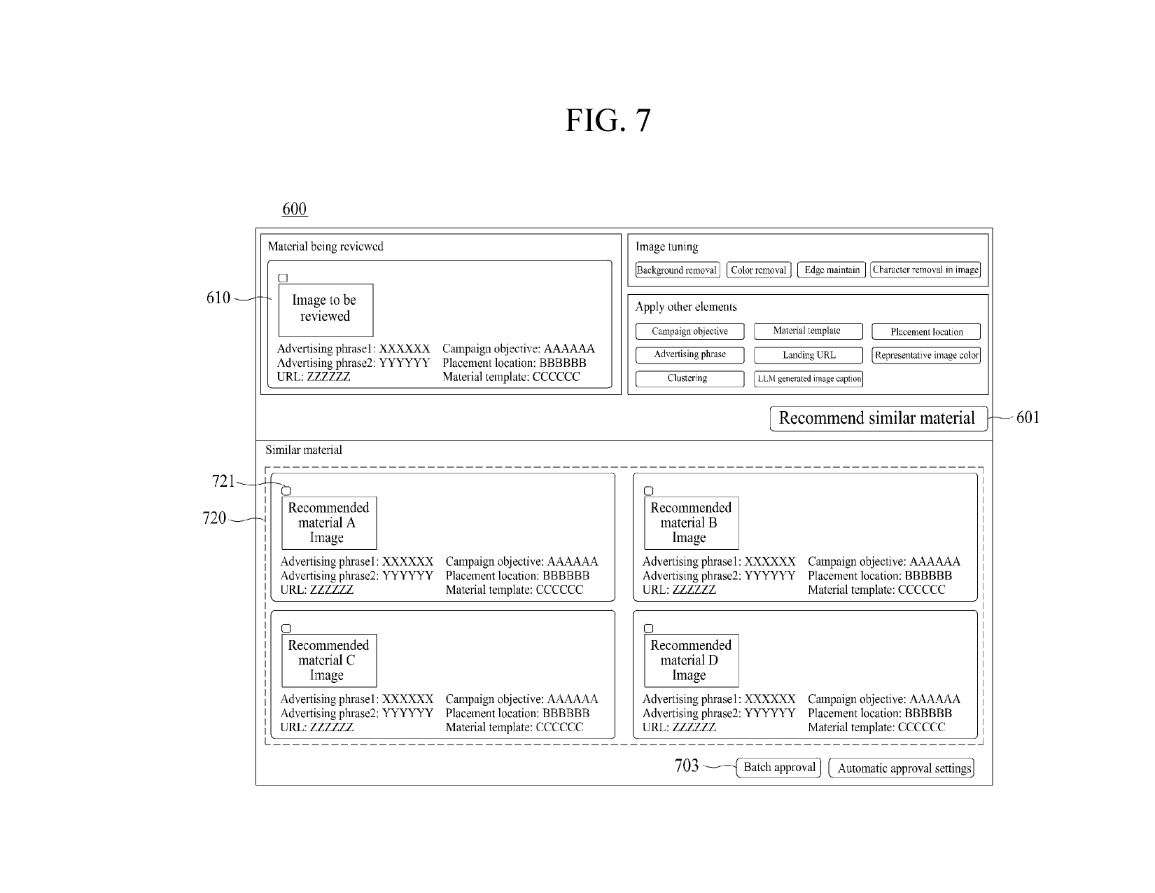

When the reviewer verifies the material to be reviewed through the 'material to be reviewed' interface 610 on the advertising review service screen 600 and enters the 'recommend similar material' interface 601, the processor 220 may provide recommended materials 720 similar to the material to be reviewed as shown in FIG. 7.

The recommended materials 720 may be selected through a recommendation logic using an image similarity algorithm, and the processor 220 may calculate image similarity between materials based on the list of materials registered to the material DB 501 and may provide a material of an image that is similar by a threshold or more to the image of the material to be reviewed as the recommended material 720.

The processor 220 may provide the recommended materials 720 similar to the material to be reviewed on the advertising review service screen 600, and may display the recommended materials 720 sorted in order of high image similarity.

The advertising review service screen 600 may include a 'select' interface 721 that allows the reviewer to select a corresponding material for each recommended material 720 with respect to the material to be reviewed.

The advertising review service screen 600 may include a 'batch approve' interface 703 for batch-approving at least one recommended material 720 selected through the 'select' interface 721 with the material to be reviewed.

When the reviewer selects at least one recommended material 720 through the 'select' interface 721 on the advertising review service screen 600 and then enters the 'batch approve' interface 703, the processor 220 may batch-approve the selected recommended material 720 and the material to be reviewed.

Referring again to FIG. 6, the advertising review service screen 600 may further include an 'option settings' interface 602 for setting an option for the image similarity algorithm.

The option for the image similarity algorithm refers to an option that may be applied in the process of calculating similarity between images registered as materials, and may include an image tuning option and factors (other elements) additionally utilized to calculate the similarity.

The image tuning option refers to a method of preprocessing an image that is subject to similarity calculation, and may include background removal, color removal (black and white processing), edge detection (maintaining only edge), and character removal. For example, in the case of selecting 'background removal' as the image tuning option, background of each of images registered as advertising materials is removed and then, similarity between images with the background removed is calculated.

Factors additionally utilized for similarity calculation as other element options may include a campaign objective, a creative template, a placement location, an advertising phrase, a landing URL, representative image color, clustering, a large language model (LLM) generated image caption, and the like. By comparing the campaign objective, the creative template, the placement location, the advertising phrase, the landing URL, and the representative image color between materials as additional factors when calculating the image similarity, the similarity with the material to be reviewed is calculated. In the case of clustering, the clustering quantity for calculating the image similarity is directly set or automatically set, and the similarity with the material to be reviewed is calculated based on a set clustering condition. In the case of the LLM generated image caption, a caption that describes an image registered as an advertising material may be generated through a large language model (LLM), such as generated pre-trained transformer (chatGPT), so when calculating the image similarity, the similarity with the material to be reviewed is calculated by comparing image captions between materials.

The reviewer may select at least one of the image tuning option and other element options through the 'option settings' interface 602, so the processor 220 may find an image of a material similar to the material to be reviewed by applying the option selected by the reviewer to the image similarity algorithm.

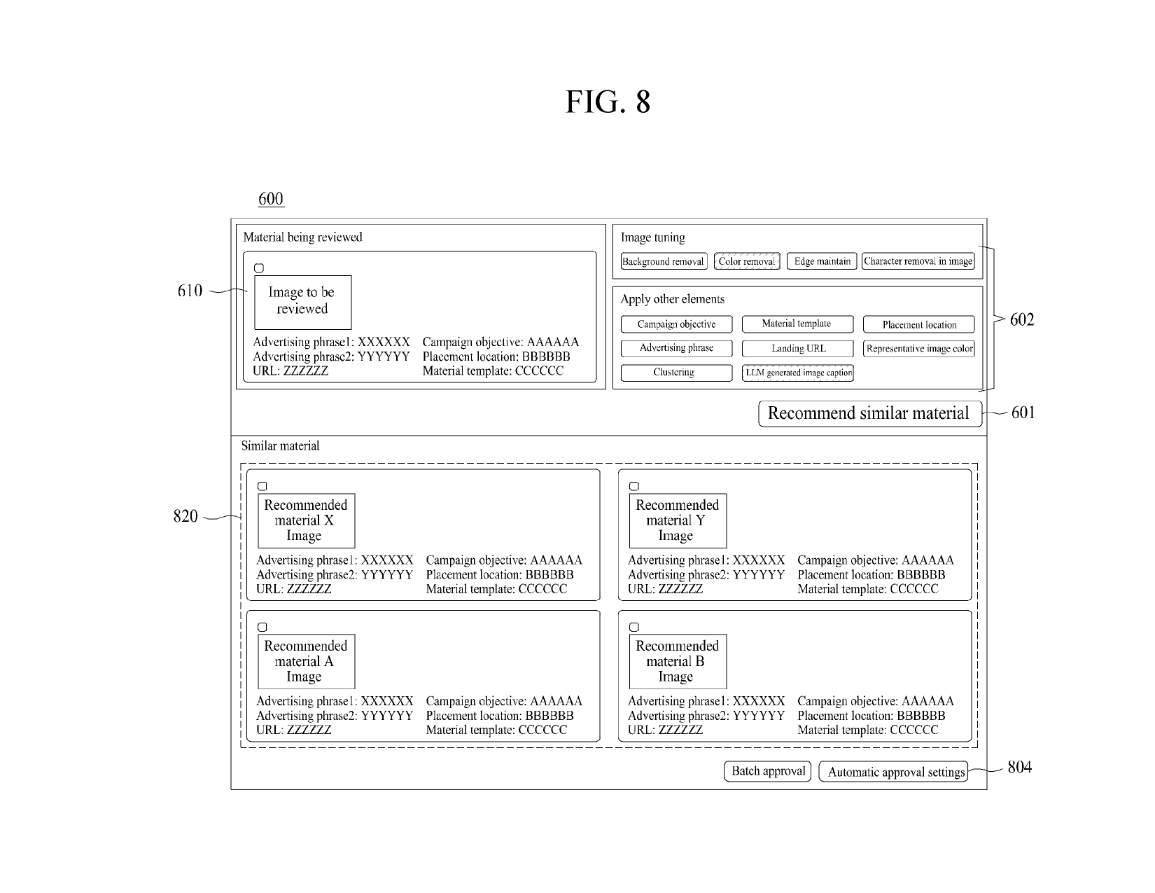

For example, referring to FIG. 8, when the reviewer selects the 'color removal 'option and the 'LLM generated image caption' option through the 'option settings' interface 602 and, in this state, enters the 'recommend similar material' interface 601, image tuning of removing color of each of images registered as advertising materials is initially performed according to the 'color removal' option. Then, the similarity between images with the color removed is calculated and, here, the final image similarity may be calculated by comparing image captions generated through the LLM according to the 'LLM generated image caption' option.

The processor 220 may provide a material of an image that is similar by a threshold or more to the image of the material to be reviewed through the similarity calculation process that includes image tuning according to the 'color removal' option and the similarity between image captions according to the 'LLM generated image caption' option.

In addition to a batch approval method for approving at least one material selected by the reviewer from among the recommended materials 720, 820 along with the material to be reviewed, an automatic approval method through advance settings of the reviewer may also be applied to the material to be reviewed.

Referring to FIG. 8, the advertising review service screen 600 may further include an 'automatic approval settings' interface 804 for setting an automatic approval condition for the material to be reviewed.

The reviewer may select at least one of the image tuning option and other element options through the 'option settings' interface 602, and may use an option selected by the reviewer as automatic review approval settings through the 'automatic approval settings' interface 804.

Although the reviewer does not select a material to be approved from among the recommended materials 720, 820 one by one, the reviewer may set automatic approval. In this case, a material selected as a recommended material through a recommendation logic using the image similarity algorithm to which the automatic approval setting option is applied may be automatically approved.

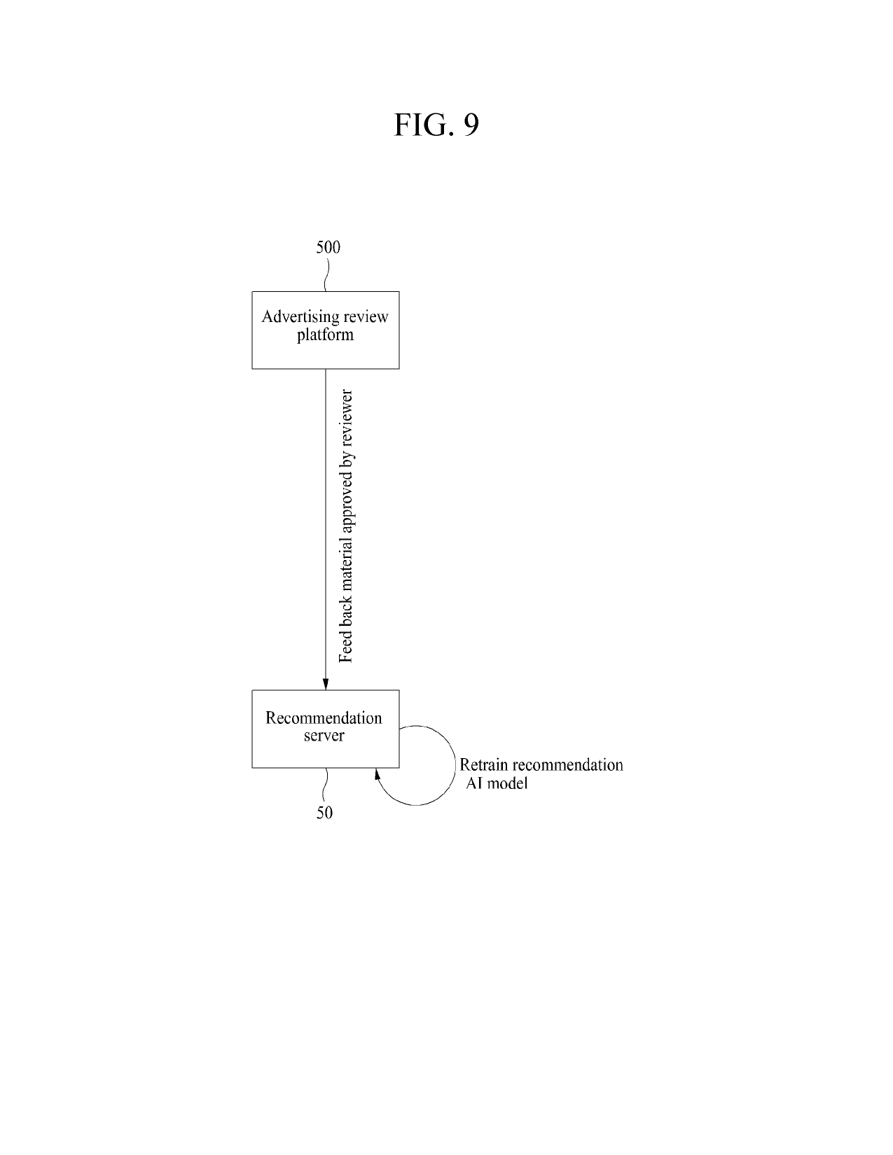

FIG. 9 illustrates an example of training a material recommendation model according to at least one example embodiment.

Referring to FIG. 9, the processor 220 may feed back, to the recommendation server 50, a material that is selected by the reviewer from among the recommended materials 720, 820 and approved together with the material to be reviewed through the advertising review platform 500. The material approved together with the material to be reviewed through the reviewer's selection may be utilized as a dataset for learning of the recommendation server 50. Depending on example embodiments, a material selected by the reviewer from among the recommended materials 720, 820 may be used as a correct answer dataset and remaining materials not selected by the reviewer may be utilized as an incorrect dataset.

The recommendation server 50 includes a material recommendation model (AI model for material recommendation) based on the image similarity algorithm, and may perform reinforcement learning on the material recommendation model using approved materials with the material to be reviewed according to the reviewer's selection. For example, transfer-learning, fine-tuning, and the like may be used for a reinforcement learning method.

According to some example embodiments, it is possible to more quickly and efficiently perform a review procedure by providing a function of batch-reviewing materials similar to a material to be reviewed in an advertising review process. The present invention aims to resolve the inefficiency where a reviewer must manually and individually review all advertising materials flowing in large volumes. The purpose of providing materials similar to the material to be reviewed is to enhance the efficiency and consistency of the advertising material review process, thereby enabling batch review. The reviewer can check the list of recommended similar materials and process some or all of them for batch approval (or disapproval) along with the material to be reviewed. This significantly reduces the time and effort spent on individual material review. Furthermore, this function can be utilized to improve review accuracy, such as by comparing the similarity between the current material and advertising materials that were previously intentionally rejected or were "No-Show" (not approved/displayed) to prevent those materials from undergoing unnecessary review again.

Also, according to some example embodiments, it is possible to provide an optimized review environment by selectively applying at least one of various options to a similarity-based recommendation logic and by recommending materials similar to a material to be reviewed.

The apparatuses described herein may be implemented using hardware components, software components, and/or the combination of the hardware components and the software components. For example, the apparatuses and the components described herein may be implemented using one or more computers or processing devices, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, instructions, or some combinations thereof, for independently or collectively instructing or configuring the processing device to operate as desired. Software and/or data may be embodied permanently or temporarily in any type of machine, component, physical equipment, or computer storage medium or device, to be interpreted by the processing device or to provide instructions or data to the processing device. The software also may be distributed over network coupled computer systems so that the software is stored and executed in a distributed fashion. The software and data may be stored by one or more computer readable storage mediums.

The methods according to the example embodiments may be recorded in non-transitory computer-readable media including program instructions executable through various computer methods. Here, the media may continuously store computer-executable programs or may transitorily store the same for execution or download. Also, the media may be various types of recording devices or storage devices in a form in which one or a plurality of hardware components are combined. Without being limited to a media directly connected to a computer system, the media may be distributed over the network. Examples of the media include magnetic media such as hard disks, floppy disks, and magnetic tapes; optical media such as CD ROM disks and DVDs; magneto-optical media such as floptical disks; and hardware devices that are specially designed to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

The foregoing description has been provided for purposes of illustration of the present invention. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the present invention.

What is claimed is:

1. An advertising material review method of a computer device comprising at least one processor, the method comprising:
registering, by the at least one processor, a material input from an advertiser as a material to be reviewed;
recommending, by the at least one processor, materials similar to the material to be reviewed based on similarity between the similar materials and the material to be reviewed; and
batch-approving, by the at least one processor, at least one material among the similar materials and the material to be reviewed.

2. The method of claim 1, wherein the registering of the input material comprises managing the material registered by the advertiser through a material database (DB) by listing the input material as the material to be reviewed.

3. The method of claim 1, wherein the recommending of the similar materials comprises recommending materials of images similar to an image of the material to be reviewed using similarity between the image of the material to be reviewed with respect to images registered as advertising materials.

4. The method of claim 1, wherein the recommending of the similar materials comprises calculating similarity between features extracted from the image of the material to be reviewed with respect to images registered as advertising materials, and selecting images having a similarity greater than or equal to a threshold with an image of the material to be reviewed as the recommended similar materials.

5. The method of claim 1, wherein the batch-approving comprises approving at least one material selected by a reviewer from among the similar materials and the material to be reviewed.

6. The method of claim 1, wherein the recommending of the similar materials comprises:
performing image tuning on images registered as advertising materials according to an option requested by a reviewer; and
selecting an image similar to an image of the material to be reviewed as the recommended similar materials based on similarity between tuned images.

7. The method of claim 6, wherein the image tuning comprises at least one of background removal, color removal, edge detection, and character removal.

8. The method of claim 1, wherein the recommending of the similar materials comprises calculating image similarity by comparing an additional factor between advertising materials according to an option requested by a reviewer when calculating similarity between images with respect to images registered as advertising materials.

9. The method of claim 8, wherein the additional factor includes at least one of a campaign objective, a creative template, a placement location, an advertising phrase, a landing uniform resource locator (URL), and a representative image color.

10. The method of claim 8, wherein the additional factor includes an image caption that is generated through a large language model (LLM) with respect to the images registered as the advertising materials.

11. The method of claim 1, further comprising:
training, by the at least one processor, a recommendation model for the similar materials using a material approved with the material to be reviewed.

12. A non-transitory computer-readable recording medium storing instructions that, when executed by a processor, cause the processor to execute the advertising material review method of claim 1 on the computer device.

13. A computer device comprising:
at least one processor configured to execute computer-readable instructions,
wherein the at least one processor is configured to:
register a material input from an advertiser as a material to be reviewed;
recommend materials similar to the material to be reviewed based on similarity between the similar materials and the material to be reviewed; and
a process of batch-approving at least one material among the similar materials and the material to be reviewed.

14. The computer device of claim 13, wherein the at least one processor is configured to recommend materials of images similar to an image of the material to be reviewed using similarity between the image of the material to be reviewed with respect to images registered as advertising materials.

15. The computer device of claim 13, wherein the at least one processor is configured to calculate similarity between features extracted from the image of the material to be reviewed with respect to images registered as advertising materials, and to select images having a similarity greater than or equal to a threshold with an image of the material to be reviewed as the recommended similar materials.

16. The computer device of claim 13, wherein the at least one processor is configured to approve at least one material selected by a reviewer from among the similar materials and the material to be reviewed.

17. The computer device of claim 13, wherein the at least one processor is configured to,
perform image tuning on images registered as advertising materials according to an option requested by a reviewer, and
select an image similar to an image of the material to be reviewed as a recommended similar materials based on similarity between tuned images.

18. The computer device of claim 13, wherein the at least one processor is configured to calculate image similarity by comparing an additional factor between advertising materials according to an option requested by a reviewer when calculating similarity between images with respect to images registered as advertising materials.

19. The computer device of claim 18, wherein the additional factor includes an image caption that is generated through a large language model (LLM) with respect to the images registered as the advertising materials.

20. The computer device of claim 13, wherein the at least one processor is configured to train a recommendation model for the similar materials using a material approved with the material to be reviewed.
